(19) United States
(12) Patent Application Publication
(10) Pub. No.: US 2020/0320527 A1
(43) Pub. Date: Oct. 8, 2020

(54) METHOD FOR DIGITAL CURRENCY TRANSACTION WITH AUTHORIZATION OF MULTIPLE PRIVATE KEYS

(71) Applicant: CoolBitX Ltd., Grand Cayman (KY)

(72) Inventors: Jay Zhuang, Taipei City (TW); SHIH-MAI OU, Taipei City (TW)

(21) Appl. No.: 16/373,660

(22) Filed: Apr. 3, 2019

(51) Int. Cl. G06Q 20/38; H04L 9/14; H04L 9/30; H04L 9/08; G06Q 20/06; G06Q 20/32

(52) U.S. Cl. CPC G06Q 20/3823; H04L 9/14; H04L 9/30; H04L 9/0861; G06Q 2220/00; G06Q 20/3829; G06Q 20/065; G06Q 20/3825; G06Q 20/3223; H04L 9/0819

(57) ABSTRACT

The present invention relates to a transaction method of digital currency, comprising the following steps: user information is provided to three terminals, and the terminals will generate a set of a public key and a private key respectively; subsequently, every terminal obtains a transaction public key by combining three public keys; then verification information is provided and compared to match the user information, such that one of the terminals obtains two or more electronic signatures; finally, the digital currency is transferred according to the transaction public key together with two or more electronic signatures. By doing so, the electronic signatures corresponding to the private keys need to be obtained from at least two terminals to transfer the digital currency of the transaction public key. So, even a theft steals one of the private keys, the theft still cannot transfer the digital currency by the stolen private key.

### FIELD OF THE DISCLOSURE

The present disclosure relates to a digital currency transaction method capable of reducing the risk of being stolen in digital assets, and more particularly, to a transaction method where two or more electronic signatures are required to be obtained before transferring the digital currency.

### BACKGROUND

With the technology going forward, many transactions and payment methods have been gradually replaced by integrated circuit (IC) cards. The memory set inside the IC card can store the information of the cardholders, and is widely applied in various occasions. For example, ATM cards, financial cards, credit cards, telephone cards, and stored value cards are currently common IC cards. According to the way of storing and reading data, IC cards can be generally divided into three types: contact interface, contactless interface and composite interface.

Take a financial card with the function of credit card and ATM card for example. The ATM requires the cardholder to input a pre-set password to obtain the right of using the financial card before using the financial card to perform transactions or services through the ATM. Therefore, even if the financial card is lost or stolen, the non-original cardholder cannot steal the cash through the ATM because of not knowing the pre-set password. But, the ATM only determines whether to make cash withdrawal according to the preset password, and the ATM cannot determine whether the financial card is of the correct original cardholder, such that if the non-original cardholder knows the pre-set password, the ATM will still make cash withdrawal, so the non-original cardholder can steal the cash. Furthermore, when the cardholder uses the financial card for consumption, the cardholder will be required to sign the name of the cardholder on the transaction document, such that if the financial card is lost or stolen, the non-original cardholder easily forges a signature or makes fraud charges to cause damage to property.

Furthermore, with the rapid advancement of wireless transmission technology, some ICs adopt wireless transmission technology (RFID/Radio-frequency identification), and such radio frequency technology is most frequently applied in consumption transactions in smaller amount, such as taking public transportation, for example, bus, mass rapid transit, and the like. However, in the case of such small amount of consumption to pursue speed and convenience, inputting a password or signing the name of the cardholder will not be required when the transaction is made. Therefore, as long as the IC card that uses the wireless sensor for consuming is lost or stolen, the non-original cardholder who picks up the IC card can directly perform the consumption transaction until the IC card is deactivated or the amount of internal storage runs out.

Furthermore, as for the IC card used for an access control system, for speed and convenience, the cardholder usually can enter and exit area with access control as long as holding the correct IC card. Therefore, when the IC card used for the access control system is lost or stolen, the non-original cardholder who takes the IC card can also directly enter and exit the access control area through the obtained IC card.

As can be seen from above explanation, as long as the current common IC card is lost and taken by the non-original cardholder, the non-original cardholder can steal the digital assets through the obtained IC card, thereby causing financial loss to the original cardholder.

### SUMMARY

The main purpose of the present invention is that two or more electronic signatures are required to be obtained before transferring the digital currency. Therefore, even if a stealer steals one of the private keys, the stealer still can't transfer the digital currency via the stolen private key, so that the digital currency can be avoided from being stolen by the stealer.

To achieve above purpose, a method for digital currency transaction with authorization of multiple private keys according to the present invention comprises the following steps: a public key and private key generating step: user information indicating the user identity is provided, and a first terminal, a second terminal, and a third terminal separately generate a set of public key and private key corresponding to the user information, such that the first terminal has a first private key and a first public key, the second terminal has a second private key and a second public key, and the third terminal has a third private key and a third public key; a transaction public key generating step: the first terminal, the second terminal and the third terminal obtain a transaction public key through combining of the first public key, the second public key and the third public key, and the transaction public key can authorize the transfer of the digital currency according to two or more of a first electronic signature corresponding to the first private key, a second electronic signature corresponding to the second private key and a third electronic signature corresponding to the third private key; a private key verifying step: verification information with user's personal information is provided, and whether the verification information is consistent with the user information is verified, and when the verification information is consistent with the user information, one of the first terminal, the second terminal and the third terminal has two or more of the first electronic signature, the second electronic signature and the third electronic signature; and a currency transferring step: transaction information is formed, and two or more of the first electronic signature, the second electronic signature, the third electronic signature can authorize the transaction public key to transfer the digital currency of the transaction public key according to the transaction information.

In a preferred embodiment, in the public key and private key generating step, the user information is sent to the first terminal, the second terminal and the third terminal, and after the first terminal, the second terminal and the third terminal receive the user information, first terminal, the second terminal and the third terminal separately generate the set of the public key and the private key.

However, in the transaction public key generating step, the first terminal obtains the second public key and the third public key, such that the first terminal has the first public key, the second public key and the third public key; the first terminal combines the first public key, the second public key and the third public key to form the transaction public key, and sends the transaction public key to the second terminal and the third terminal.

In another preferred embodiment, in the public key and private key generating step, the first terminal, the second terminal and the third terminal separately have at least one set of unset initial public key and unset initial private key, and the unset initial public key and the unset initial private key are set to be converted into the public key and the private key according to the user information.

However, in the transaction public key generating step, the first terminal, the second terminal and the third terminal all separately obtain the first public key, the second public key and the third public key; the first terminal, the second terminal and the third terminal all separately combine the first public key, the second public key and the third public key to form the transaction public key.

In two above-mentioned embodiments, the method for digital currency transaction with authorization of multiple private keys further comprises: a public key and -private key regenerating step: one of the first terminal, the second terminal and the third terminal generates a fourth private key and a fourth public key corresponding to the user information; a replacing step: two of the first public key, the second public key and the third public key combine with the fourth public key to form a remade transaction public key used for escrowing the transaction public key, and the digital currency of the transaction public key is transferred to the remade transaction public key.

As can be seen from above explanation, the present invention has a feature: the first terminal, the second terminal and the third terminal three separately have a private key and a public key, and all the public keys combine to form a transaction public key, and the transaction public key needs two or more electronic signatures to transfer the digital currency. Thus, when the digital currency key is to be transferred, the electronic signatures must be obtained from at least two terminals before the digital currency can be transferred. Therefore, even if a stealer steals one of the private keys, the stealer still can't transfer the digital currency via the stolen private key so that the digital currency can be avoided from being stolen by the stealer.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts. In the figures:

FIG. 1 is a schematic illustrating flowchart of a digital currency transaction method according to a first preferred embodiment of the present invention;

FIG. 2 is a schematic illustrating block diagram of the digital currency transaction system;

FIGS. 3A to 3C are schematic illustrating of the public key and private key generating step;

FIG. 4 is a schematic illustrating of the transaction public key generating step in FIG. 1;

FIG. 5 is a schematic illustrating of the private key verifying step in FIG. 1,

FIG. 6 is a schematic illustrating of the currency transferring step in FIG. 1;

FIG. 7 is a schematic illustrating the public key and private key generating step according to a second preferred embodiment;

FIG. 8 is a schematic illustrating the transaction public key generating step according to a second preferred embodiment;

FIG. 9 is a schematic illustrating the private key verifying step according to a third preferred embodiment;

FIG. 10 is a schematic illustrating the currency transferring step according to a third preferred embodiment;

FIG. 11 is a schematic illustrating flowchart of a digital currency transaction method of the present invention according to a fourth preferred embodiment;

FIG. 12 is a schematic illustrating a public key and private key regenerating step according to a fourth preferred embodiment;

FIG. 13 is a schematic illustrating a replacing step according to a fourth preferred embodiment; and

FIG. 14 is a schematic illustrating the digital currency of the transaction public key transferred to the remade transaction public key.

### DETAILED DESCRIPTION OF PREFERRED EMBODIMENTS

In order to further understand the structure, usage and features of the present invention more clearly, the present invention is described in detail below with references to the accompanying drawings and specific preferred embodiments:

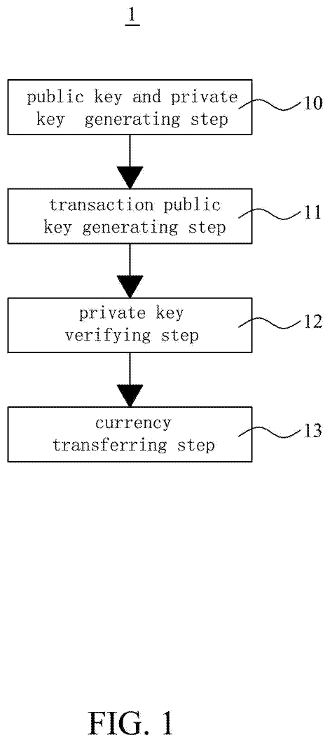

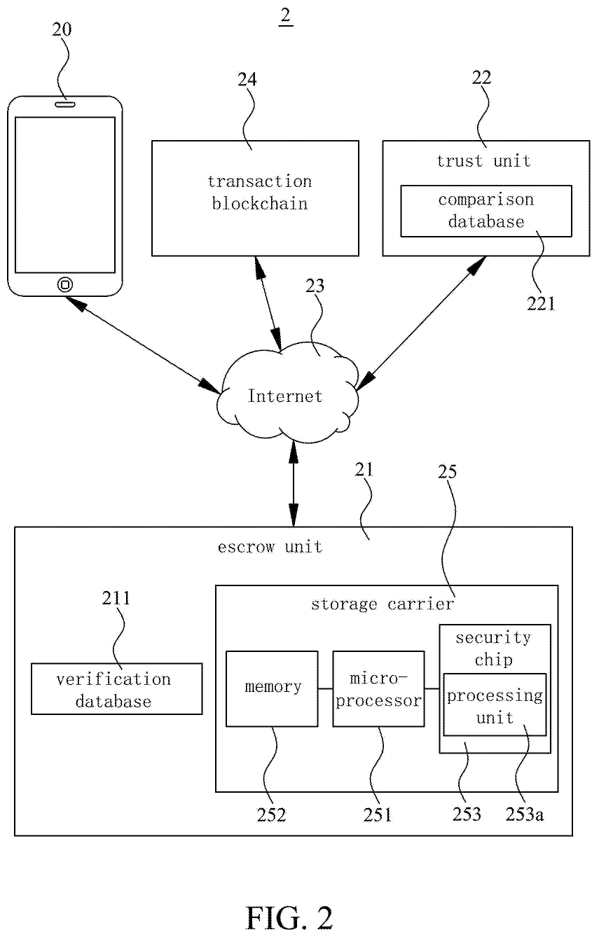

Please refer to FIGS. 1 and 2. In a first preferred embodiment, a digital currency transaction method 1 of the present invention is used in conjunction with a digital currency transaction system 2. As shown in FIG. 2, the digital currency transaction system 2 has a first terminal 20, a second terminal 21 and a third terminal 22. The first terminal 20 is set as a mobile phone, a computer or a tablet used by a user, and the second terminal 21 is set as an escrow unit capable of managing the public key, and the third terminal 22 is set as a trust unit capable of managing the public key. However, the first terminal 20 set as a mobile phone, a computer or a tablet, the second terminal 21 set as an escrow unit and the third terminal 22 set as a trust unit are merely in an attempt to explain conveniently. That is, the first terminal 20 can be set as an escrow unit, the second terminal 21 can be set as a trust unit, and the third terminal 22 can be set as a mobile phone, a computer or a tablet.

In the present embodiment, the first terminal 20 set as a mobile phone, a computer or a tablet can be actively connected to an Internet 23, and the Internet 23 is simultaneously connected to the second terminal 21, the third terminal 22, and a transaction blockchain 24, such that all of the first terminals 20 can be connected to the second terminal 21, the third terminal 22, and the transaction blockchain 24 via the Internet 23.

The second terminal 21 set as an escrow unit has a verification database 211 for storing information content, and can provide a storage carrier 25. Furthermore, the third terminal 22 set as a trust unit has a comparison database 221 for storing the information content, and the transaction blockchain 24 stores a plurality of public keys of various users, wherein each the public key has digital currency and a transaction address. In the present embodiment, the storage carrier 25 cannot be directly connected to the Internet 23, but each the storage carrier 25 can be selectively one-to-one connected or disconnected to one of the plurality of first terminals 20. And when the storage carrier 25 is connected to the first terminal 20, the storage carrier 25 can be connected to the Internet 23 via the electronic device. Wherein, the storage carrier 25 is equipped with a microprocessor 251 capable of processing information, a memory 252 capable of storing information, and a security chip 253 for storing important information, and both the memory 252 and the security chip 253 are electrically connected to the microprocessor 251. Wherein, the security chip 253 has a processing unit 253a capable of processing information, and in this embodiment, the storage carrier 25 is configured as an integrated circuit (IC) card.

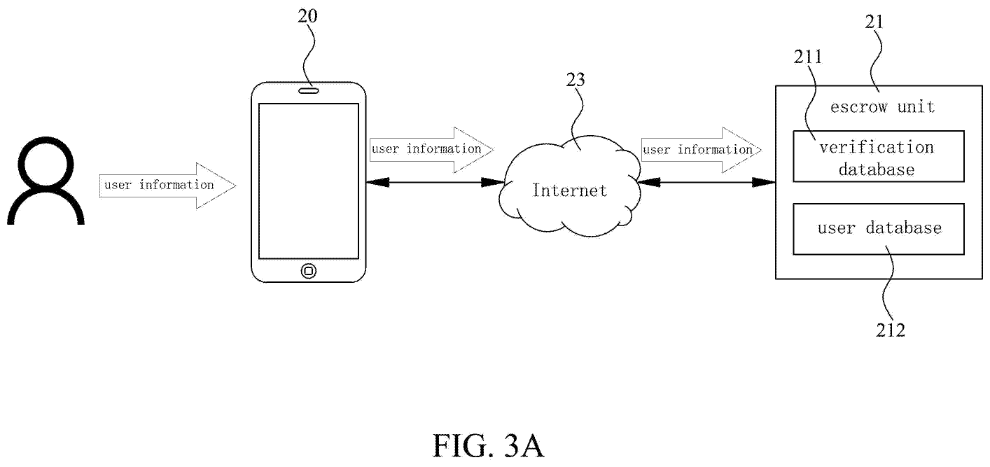

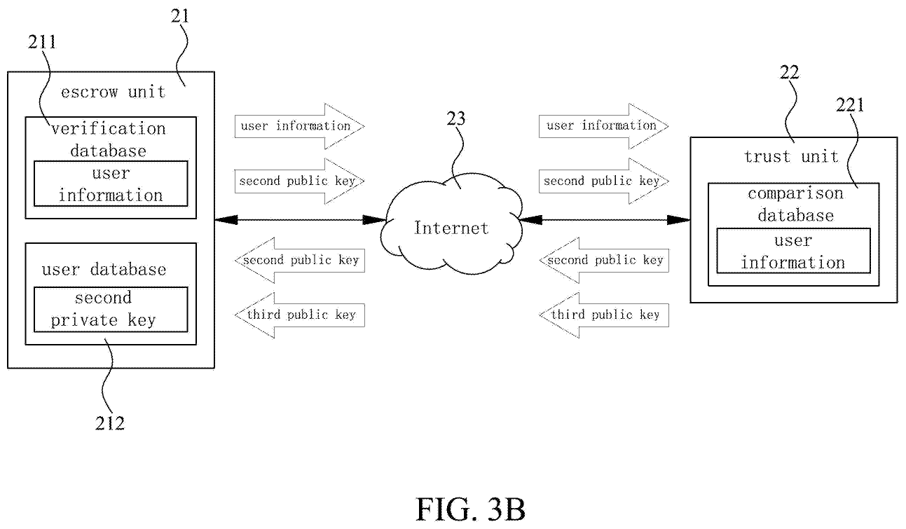

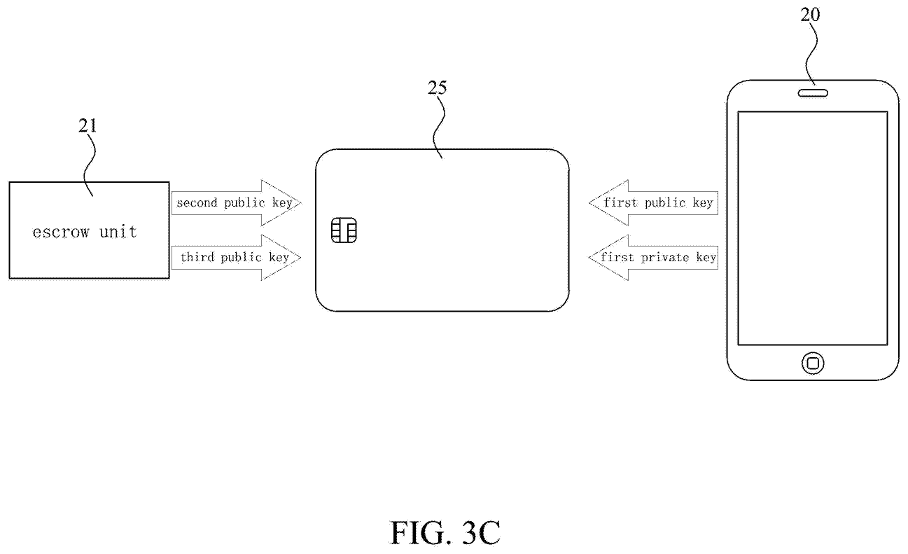

Please refer to FIGS. 1 and 3A. In practical application, firstly a public key and private key generating step 10 is carried out: a user inputs user information indicating the user identity to the first terminal 20, and the first terminal 20 sends the user information to the second terminal 21, so that the second terminal 21 creates a user database 212 stored in the second terminal 21 according to the user information and stores the user information into the verification database 211, and then the second terminal 21 further generates a second private key for authorizing the transfer of the digital currency and a second public key corresponding to the second private key according to the user database 212.

Please refer to FIG. 3B, the second terminal 21 stores the second private key into the user database 212 and sends the user information and the second public key to the third terminal 22; the third terminal 22 stores the user information into the comparison database 221 and generates a third private key for authorizing the transfer of the digital currency and a third public key corresponding to the third private key according to the user information and the second public key, wherein the third terminal 22 stores the third private key and is adapted to manage the third key.

Please refer to FIG. 3C, subsequently, the third terminal 22 sends the second public key and the third public key to the second terminal 21. The second terminal 21 stores the second public key and the third public key into the memory 252 of the storage carrier 25 and provides the storage carrier 25 having the second public key and the third public key to the user. Then, after the user obtains the storage carrier 25, the first terminal 20 generates a first private key for authorizing the transfer of the digital currency and a first public key corresponding to the first private key according to the user information. Wherein, the first terminal 20 sends the first private key to the storage carrier 25, such that the security chip 253 of the storage carrier 25 stores the first private key; furthermore, the first terminal 20 then sends the first public key to the storage carrier 25, the second terminal 21 and the third terminal 22, such that the memory 252 of the storage carrier 25, the user database 212 of the second terminal 22 and the third terminal 22, three all store the first public key, and thus the public key and private key generating step 10 is completed.

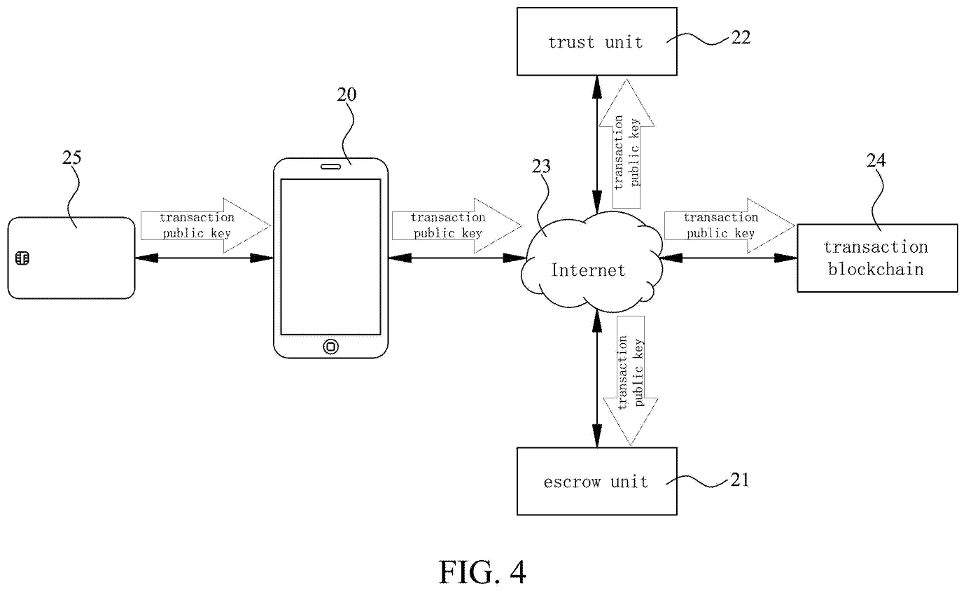

Please refer to FIGS. 1 and 4. Subsequently, a transaction public key generating step 11 is carried out. When the memory 252 of the storage carrier 25 has the first public key, the second public key and the third public key stored therein, the microprocessor 251 of the storage carrier 25 combines the first public key, the second public key and the third public key to form a transaction public key with the digital currency, and the microprocessor 251 sets the transaction public key to a transaction mode where at least two electronic signatures corresponding to the private keys are required before transferring the digital currency. Then, the microprocessor 251 sends the transaction public key of the transaction mode to the first terminal 20, and subsequently the first terminal 20 sends the transaction public key to the second terminal 21, the third terminal 22 and the transaction blockchain 24, such that the first terminal 20, the second terminal 21, the third terminal 22 and the transaction blockchain 24, four all can have the transaction public key stored therein.

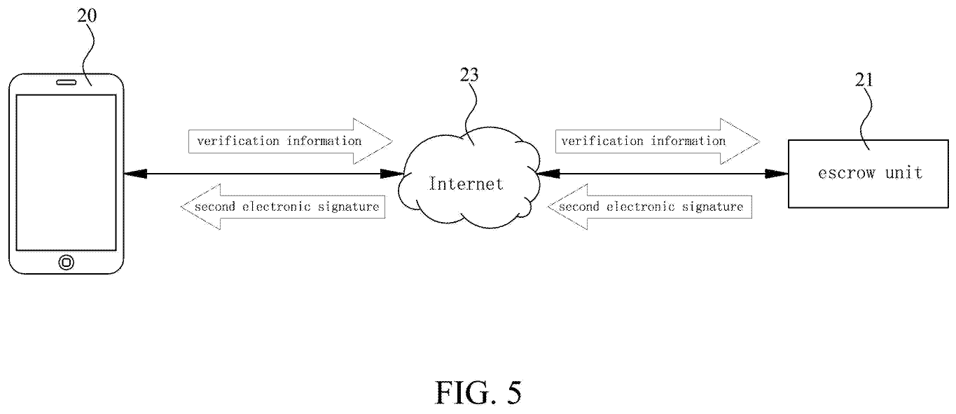

Please refer to FIGS. 1 and 5. When the user want to transfer the digital currency, the first terminal 20 receives verification information with user's personal information formed by input from the user, and the first terminal 20 sends the verification information to the second terminal 21. When the second terminal 21 receives the verification information, the second terminal 21 would confirm whether the verification information is consistent with the user information of verification database 211. When the second terminal 21 confirms that the information content of the verification information is consistent with the information content of the user information, the second terminal 21 would convert the second private key to form a second electronic signature transmitted to the first terminal 20. When the first terminal 20 receives the second electronic signature, the first terminal 20 will request the storage carrier 25 to use the first private key to make the microprocessor 251 in the storage carrier 25 obtain the first private key from the memory 252 in the storage carrier 25, and the first private key is converted to form a first electronic signature transmitted to the first terminal 20. Therefore, the first terminal 20 simultaneously has both the first electronic signature and the second electronic signature. Thus, a private key verifying step 12 is completed.

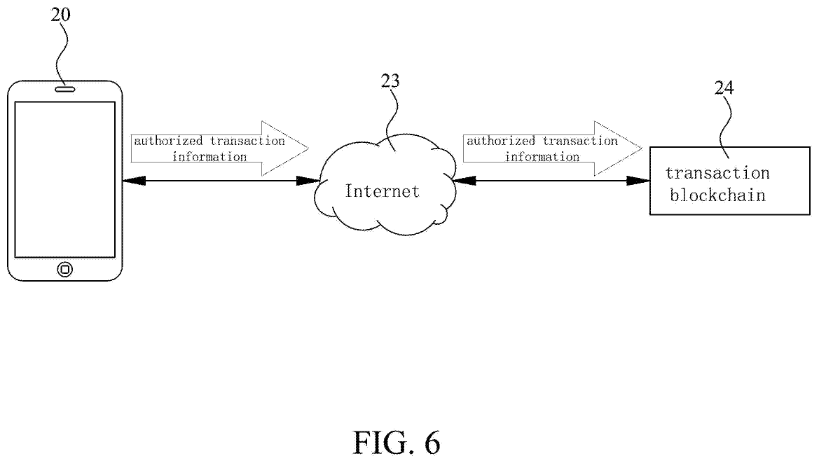

Please refer to FIGS. 1 and 6. Finally, a currency transferring step 13 is carried out. The user generates transaction information including the transaction address and the transaction amount via the first terminal 20, and the first terminal 20 makes the first electronic signature, the second electronic signature and the transaction information form authorized transaction information, and the authorized transaction information is sent to the transaction blockchain 24. Thus the transaction blockchain 24 verifies the first and second electronic signatures to confirm the correctness of the first and second private keys, and the transaction blockchain 24 can perform the transfer of the digital currency of the transaction public key according to the information content of the authorized transaction information then.

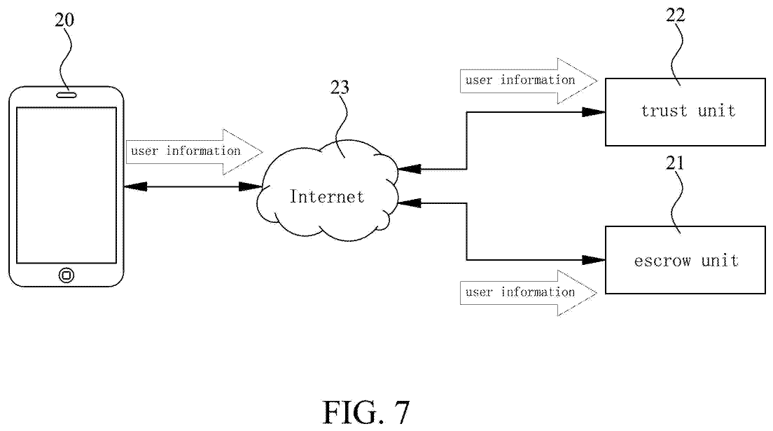

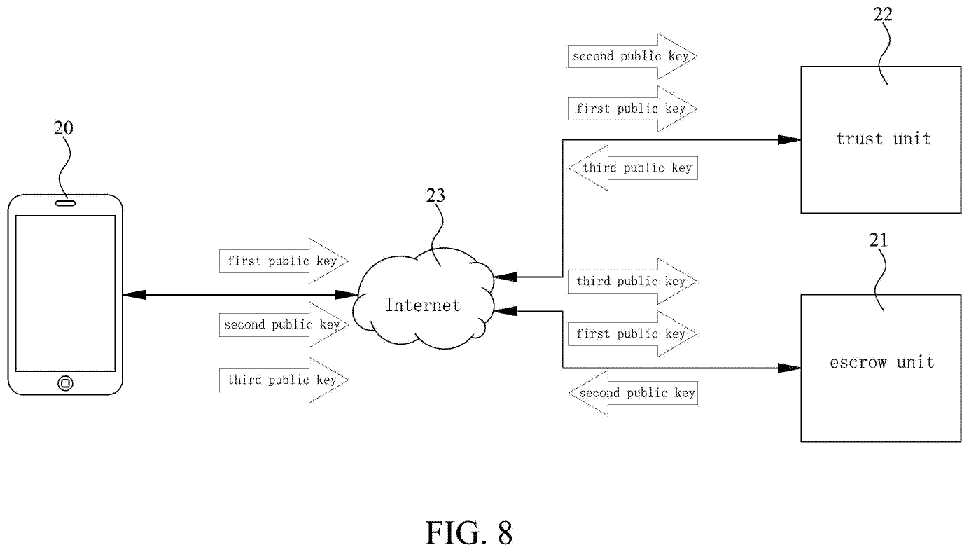

Please refer to FIGS. 7 and 8. In a second preferred embodiment, the digital currency transaction method 1 of the present invention also has a public key and private key generating step 10, a transaction public key generating step 11, a private key verifying step 12, and a currency transferring step 13. The difference between the second and the first preferred embodiment is the public key generating step 10 and the transaction public key generating step 11. As for the private key verifying step 12 and the currency transferring step 13, their procedures are the same as ones in the first preferred embodiment, which will not be repeated here again.

As shown in FIG. 7, the first terminal 20 set as a mobile phone, a computer or a tablet itself has at least one set of unset first initial public key and the unset first initial private key stored therein; the second terminal 21 set as an escrow unit itself has at least one set of unset second initial public key and the unset second initial-private key stored therein; the third terminal 22 set as a trust unit itself has at least one set of unset third initial public key and the unset third initial private key stored therein. Wherein when the first, second, and third terminal 20, 21, 22 separately receive the user information, the first terminal 20 can set one of first initial public keys and the first initial private keys according to the user information, such that the first initial public key and the first initial private key is converted into the first public key and the first private key; the second terminal 21 can set one of second initial public key and the second initial private key according to the user information, such that the second initial public key and the second initial private key is converted into the second public key and the second private key; similarly, the third terminal 22 can set one of third initial public keys and the third initial private keys according to the user information, such that the third initial public key and the third initial private key is converted into the third public key and the third private key. Thus, the public key and private key generating step 10 is completed.

As shown in FIG. 8, when the first terminal 20 generates the first public key, the first terminal 20 sends the first public key to the second terminal 21 and the third terminal 22; when the second terminal 21 generates the second public key, the second terminal 21 sends the second public key to the first terminal 20 and the third terminal 22; and when the third terminal 22 generates the third public key, the third terminal 22 sends the third public key to the first terminal 20 and the second terminal 21. And further, when the first, second, and third terminal 20, 21, 22 all separately have the first public key, the second public key, and the third public key, the first, second, and third terminal 20, 21, 22 separately combine the first public key, the second public key, and the third public key to form the transaction public key. And when the first, second, and third terminal 20, 21, 22 all have the transaction public key, the transaction public key generating step 11 is thus completed.

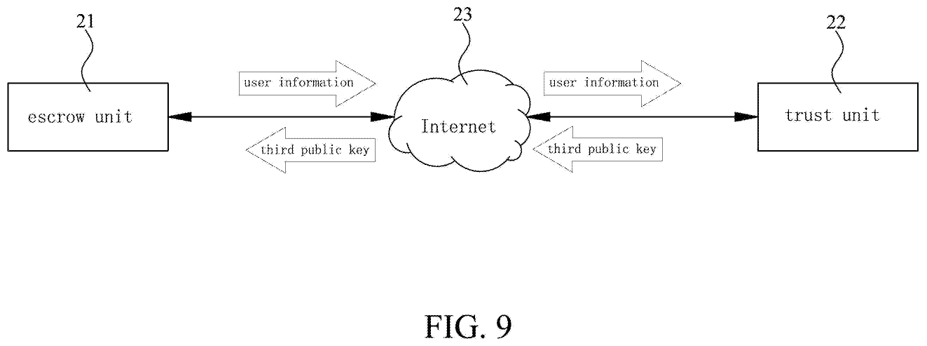

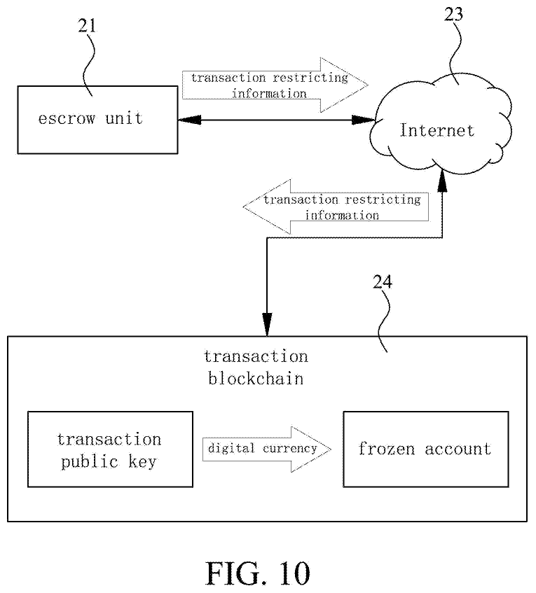

Please refer to FIGS. 9 and 10, in a third preferred embodiment, the difference between the third and the first preferred embodiment is the private key verifying step 12 and the currency transferring step 13. As shown in FIG. 9, when digital asset of unknown source is found to be transferred to the transaction public key, the second terminal 21 set as an escrow unit sends the user information stored in the verification database 211 to the third terminal 22 set as a trust unit. After verifying that the user information stared in the verification database 211 is consistent with the user information of the comparison database 221, the third terminal 22 converts the third private key to form a third electronic signature transmitted to the second terminal 21, such that the second terminal 21 has both the second private key and the third electronic signature. Whereby, the private key verifying step 12 is completed.

Please refer to FIG. 10, where performing the currency transferring, step 13, the second terminal 21 set as an escrow unit generates freeze information for freezing the flow of the digital currency and converts the second private key to form a second electronic signature. The second terminal 21 makes the second electronic signature, the third electronic signature and the freeze information form transaction restricting information, and the transaction restricting information is sent to the transaction blockchain 24, such that the transaction blockchain 24 converts the second and third electronic signature to know the information content of two, the second and third private key. Thus, according to the transaction restricting information, the transaction blockchain 24 no longer provides the transaction public key, and then transfers the digital currency of the transaction public key to a frozen account, which does not allow the digital currency of the transaction public key to be transferred out by a person of stealing, thereby reducing the risk of property damage.

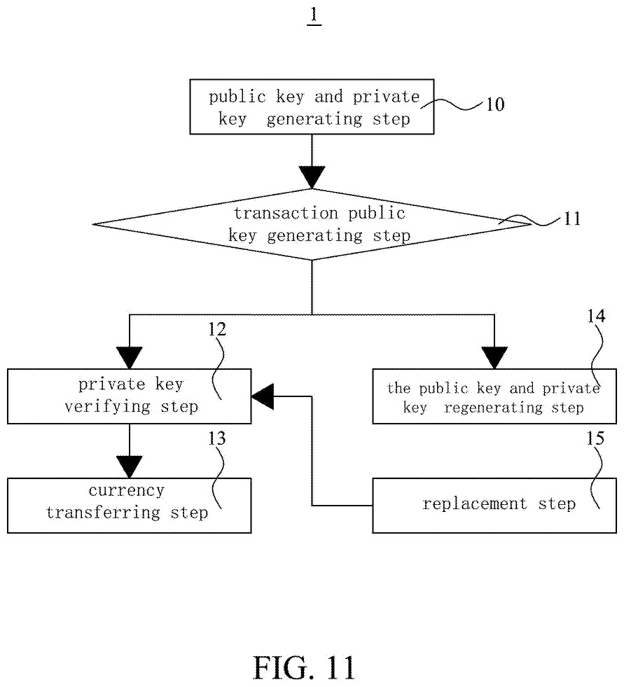

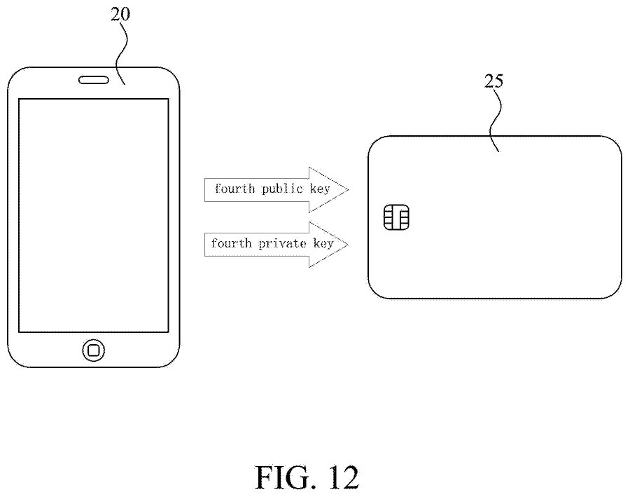

Please refer to FIG. 11. In a fourth preferred embodiment, the difference between the fourth and the first preferred embodiment is that the digital currency transaction method 1 further comprises a public key and private key regenerating step 14 and a replacement step 15. Please refer to FIGS. 11 and 12, after completing the transaction public key generating step 11, besides that the private key verifying step 12 could be carried out, the public key and private key regenerating step 14 could then be carried out. As shown in the figure, when the user loses the first private key, the user inputs the user information into the first terminal 20, and thus the first terminal 20 generates, according to the user information, a fourth private key different from the first private key and a fourth public key corresponding to the fourth private key. The first terminal 20 would further send the fourth public key to the storage carrier 25, such that the memory 252 of the storage carrier 25 removes the first public key and stores the fourth public key. Thus, the public key and private key regenerating step 14 is completed.

However, that the first terminal 20 generates the fourth private key and the fourth public key according to the user information is in attempt to explain conveniently. That is, if the second terminal 21 set as an escrow unit loses the second private key, or if the third terminal set as a trust unit loses the third private key, the second terminal 21 and the third terminal 22 also could generate the fourth private key and the fourth public key according to the user information. Wherein, when the second terminal 21 generates the fourth public key, the second terminal 21 would further remove the second public key; otherwise, when the third terminal 22 generates the fourth public key, the third terminal 22 would further remove the third public key.

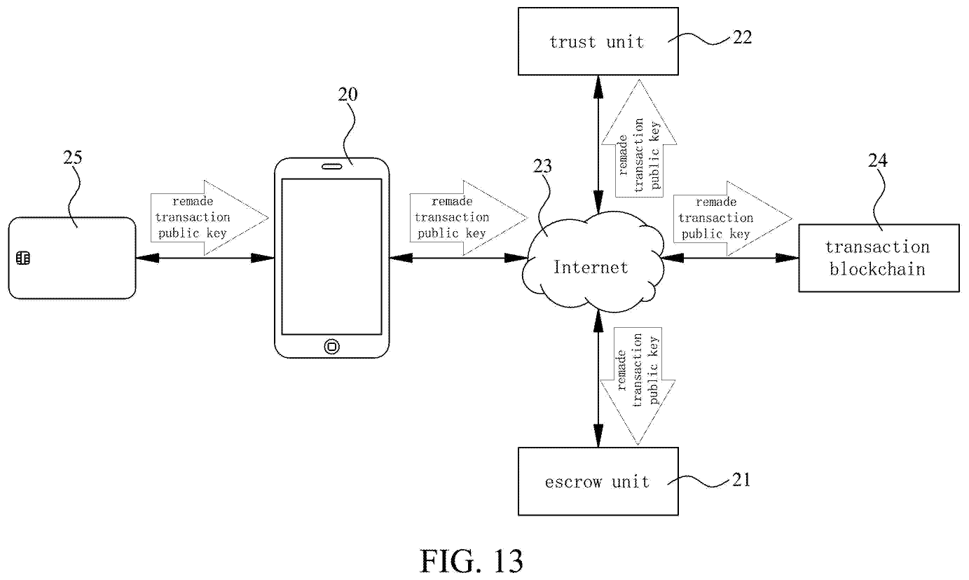

Please refer to FIGS. 11 and 13, when completing the public key and private key regenerating step 14, the memory 252 of the storage carrier 25 has the second public key, the third public key, and the fourth public key; the microprocessor 251 of the storage carrier 25 combines the second public key, the third public key and the fourth public key to form a remade transaction public key, and the microprocessor 251 sets the remade transaction public key to a transaction mode where at least two electronic signatures corresponding to the private keys are required before transferring the digital currency. Then, the microprocessor 251 sends the remade transaction public key of the transaction mode to the first terminal 20, and subsequently the first terminal 20 sends the remade transaction public key to the second terminal 21, the third terminal 22 and the transaction blockchain 24, such that the first terminal 20, the second terminal 21, the third terminal 22 and the transaction blockchain 24, four all can have the remade transaction public key stored therein.

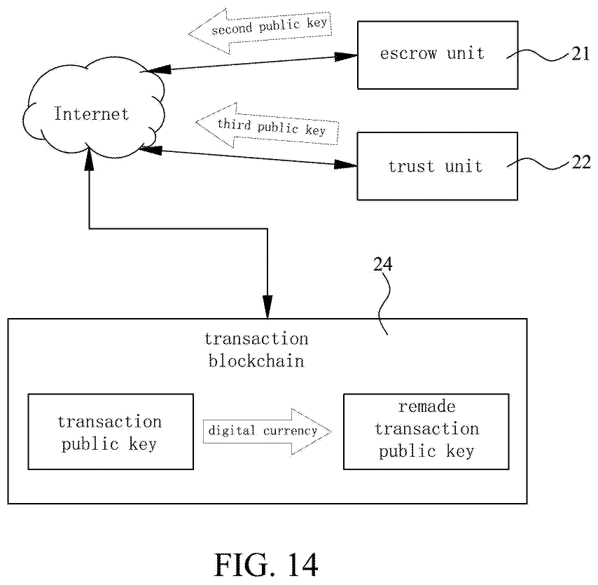

Please refer to FIG. 14. The first terminal 20 receives the verification information formed by input from the user, and the first terminal 20 sends the verification information to the second terminal 21 and the third terminal 22. When the second terminal 21 and the third terminal 22 receive the verification information, the second terminal 21 would confirm whether the verification information is consistent with the user information of verification database 211, while the third terminal 22 would confirm whether the verification information is consistent with the user information of comparison database 221. When the second and third terminal 21, 22 both confirm that the information content of the verification information is consistent with the information content of the user information, the second terminal 21 would convert the second private key to form a second electronic signature and sends the second electronic signature to the first terminal 20, while the third terminal 22 would convert the third private key to form a third electronic signature and sends the third electronic signature to the first terminal 20. The first terminal 20 sends the second and the third electronic signatures to the transaction blockchain 24, and the transaction blockchain 24 would verify the second and third electronic signatures to know the authorized content of the second and the third private keys, and thus the transaction blockchain 24 can transfer the digital currency of the transaction public key to the remade transaction public key for completing the replacing step 15.

The above-instanced embodiments are used for conveniently describing the present invention, not further to limit it. For the person skilled in the art of the disclosure, without departing from the concept of the disclosure, simple modifications or changes can be made and should be included in the following claims and their equivalents of the present application.

What is claimed is:

1. A method for digital currency transaction with authorization of multiple private keys, comprising
a public key and private key generating step, where user information indicating an user identity is provided, and a first terminal, a second terminal, and a third terminal separately generate a set of public key and private key corresponding to the user information, such that the first terminal has a first private key and a first public key, the second terminal has a second private key and a second public key, and the third terminal has a third private key and a third public key;
a transaction public key generating step, where the first terminal, the second terminal and the third terminal obtain a transaction public key through combining of the first public key, the second public key and the third public key, and the transaction public key can authorize the transfer of the digital currency according to two or more of a first electronic signature corresponding to the first private key, a second electronic signature corresponding to the second private key and a third electronic signature corresponding to the third private key;
a private key verifying step, where a verification information with user's personal information is provided, and whether the verification information is consistent with the user information is verified, and when the verification information is consistent with the user information, one of the first terminal, the second terminal and the third terminal has two or more of the first electronic signature, the second electronic signature and the third electronic signature; and
a currency transferring step, where transaction information is generated, and two or more of the first electronic signature, the second electronic signature, the third electronic signature are obtained, therefore the transaction public key transfer the digital currency of the transaction public key according to the transaction information.

2. The method for digital currency transaction according to claim 1, further comprising:
a public key and -private key regenerating step, where one of the first terminal, the second terminal and the third terminal generates a fourth private key and a fourth public key corresponding to the user information; and
a replacing step, where two of the first public key, the second public key and the third public key combine with the fourth public key to form a remade transaction public key, and two of the private keys corresponding to the first public key, the second public key and the third public key are obtained, such that the digital currency of the transaction public key can be transferred to the remade transaction public key.

3. The method for digital currency transaction according to claim 1, wherein in the public key and private key generating step, the user information is sent the first terminal, the second terminal and the third terminal, and after the first terminal, the second terminal and the third terminal receive the user information, first terminal, the second terminal and the third terminal separately generate the set of the public key and the private key.

4. The method for digital currency transaction according to claim 1, wherein in the public key and the private key generating step, the first terminal, the second terminal and the third terminal separately have at least one set of unset initial public key and an unset initial private key, and the unset initial public keys and the unset initial private keys are set to be converted into the public key and the private key according to the user information.

5. The method for digital currency transaction according to claim 1, wherein in the transaction public key generating step, the first terminal obtains the second public key and the third public key, such that the first, terminal has the first public key, the second public key and the third public key; the first terminal combines the first public key, the second public key and the third public key to form the transaction public key, and sends the transaction public key to the second terminal and the third terminal.

6. The method for digital currency transaction according to claim 1, wherein in the transaction public key generating step, the first terminal, the second terminal and the third terminal all separately obtain the first public key, the second public key and the third public key; the first terminal, the second terminal and the third terminal all separately combine the first public key, the second public key and the third public key to form the transaction public key.
